(19) United States
(12) Patent Application Publication
(10) Pub. No.: US 2007/0064554 A1
(43) Pub. Date: Mar. 22, 2007

(54) Optical disk drive and method of determining working distance

(75) Inventor: Tzu-Nan Chen, Taipei (TW)

Correspondence Address: BIRCH STEWART KOLASCH & BIRCH, PO BOX 747, FALLS CHURCH, VA, 22040-0747, US

(73) Assignee: Lite-On it Corporation

(21) Appl. No.: 11/518,935

(22) Filed: Sep. 12, 2006

(30) Foreign Application Priority Data
Sep. 21, 2005 (TW) 94132725

(51) Int. Cl. G11B 7/00

(52) U.S. Cl. 369/44.27

(57) ABSTRACT

An optical disk drive and method of determining working distance are provided. The optical disk drive includes an optical pick-up head having an objective lens to access an optical disk. Working distance is the distance between the optical disk and the objective lens. Firstly, the optical pick-up head emits a beam to the optical disk and receives a reflective beam to generate a sum signal. The objective lens is at an initial position. Next, whether the value of the sum signal is larger than a threshold value is determined. If yes, the objective lens is in a first area, otherwise the objective lens moves a first test distance away from the optical disk to check whether the optical disk is in a second area. If yes, the method is terminated, otherwise the objective lens moves a second test distance towards the optical disk to check whether the objective lens is in a third area.

This application claims the benefit of Taiwan application Serial No. 94132725, filed Sep. 21, 2005, the subject matter of which is incorporated herein by reference.

### BACKGROUND OF THE INVENTION

1. Field of the Invention

The invention relates in general to an optical disk drive and a method for determining working distance, and more particularly to an optical disk drive and a method for directly determining working distance.

2. Description of the Related Art

Referring to FIG. 1, a diagram of working distance is shown. The turn table 105 supports an optical disk. The spindle motor 101 is for rotating the optical disk. The optical pick-up head 106 emits a beam to the optical disk through an objective lens 102 and receives a reflective beam through the objective lens 102. The optical pick-up head 106 reads the optical disk by shifting the guiding rod 103. All of the above elements are disposed on a traverse 104.

The vertical distance from the objective lens 102 to the turn table 105, that is, the distance between the objective lens 102 and the optical disk when accessing the optical disk, is defined as a working distance (WD). During the assembly of the optical disk drive, the working distance must be controlled effectively and accurately.

The working distance WD1 is obtained by subtracting the vertical distance Di2 from the vertical distance Di1. The vertical distance Di1 is the distance from the guiding rod 103 to the turn table 105, and the vertical distance Di2 is the distance from the objective lens 102 to the guiding rod 103.

To obtain the vertical distance Di1, the accumulated height of the parts including the spindle motor 101, an adjusting block (not illustrated) and the traverse 104 must be controlled, lest the accumulated tolerance of the height might be too large. Therefore, the height tolerance of the parts must be checked and the inspection of parts-feeding process must be added so as to reduce tolerance level and the occurrence of errors.

However, the vertical distance Di2 may have assembly tolerance. The working distance WD1 is obtained by subtracting the vertical distance Di2 from the vertical distance Di1. As long as the accumulated tolerance of the vertical distance Di 1 and the accumulated tolerance of the vertical distance Di2 enable the working distance WD1 to comply with the standards, the obtained working distance WD1 is still acceptable.

In order to store more data on the optical disk to achieve high-density data storage, new generation optical storage medium is now under development. The above object of high-density data storage may be achieved by shortening the wavelength of the beam for accessing data or by enlarging the numerical aperture (NA) of the objective lens such that the light point becomes smaller. However, if the NA is enlarged, the working distance WD from the objective lens to the optical disk is reduced accordingly.

If the working distance WD is reduced, when the objective lens moves up and down for focusing, the objective lens is likely to collide with the optical disk due to the manufacturing tolerance of the actuator or poor servo control. Consequently, permanent damages may occur to the objective lens or the optical disk. The conventional method which accumulates the tolerance of the parts does not do much good in terms of the accuracy and precision of the working distance WD. However, if a more accurate inspection apparatus is used, the inspection cost would increase considerably.

### SUMMARY OF THE INVENTION

It is therefore an object of the invention to provide an optical disk drive and a method of determining working distance to avoid the error which occurs due to the accumulation of tolerance. The method directly measures the working distance and can do without checking the height tolerance of the parts or inspecting the parts-feeding process, hence reducing the manufacturing cost.

The invention achieves the above-identified object by providing a method for determining working distance applied to an optical pick-up head. The optical pick-up head is for accessing an optical disk and has an objective lens. The working distance is the distance between the optical disk and the objective lens. Firstly, the optical pick-up head emits a beam to the optical disk and receives a reflective beam of the optical disk to generate a sum signal. The optical pick-up head is at an initial position. Next, whether the value of the sum signal is larger than a threshold value is determined. If yes, the objective lens is in a first area, otherwise the objective lens moves a first test distance away from the optical disk to check whether the optical disk is in a second area. If yes, the method is terminated, otherwise the objective lens moves a second test distance toward the optical disk to check whether the working distance is in a third area.

The invention further achieves the above-identified object by providing an optical disk drive for accessing an optical disk. The optical disk drive includes an optical pick-up head for accessing an optical disk. The optical pick-up head has an objective lens. The distance between the optical disk and the objective lens is defined as a working distance. The optical pick-up head emits a beam to the optical disk and receives a reflective beam of the optical disk to generate a sum signal. The objective lens is at an initial position. The optical disk drive determines whether the value of the sum signal is larger than a threshold value. If yes, the objective lens is in a first area, otherwise the objective lens moves a first test distance away from the optical disk to check whether the working distance is in a second area. If the working distance is not in the second area, the objective lens moves from the initial position a second test distance toward the optical disk to check whether the objective lens is in a third area.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 illustrates a diagram of working distance;

FIG. 2 illustrates an optical disk drive according to a preferred embodiment of the invention;

FIGS. 3A˜3C illustrate a photo-detector of the optical pick-up head 210;

FIG. 3D is a relationship diagram of the the focus error signal Fe vs. the working distance;

FIG. 4 illustrates relative positions between the objective lens of the invention and the optical disk; and

FIGS. 5A and 5B are a flowchart of a method for determining the working distance according to a preferred embodiment of the invention.

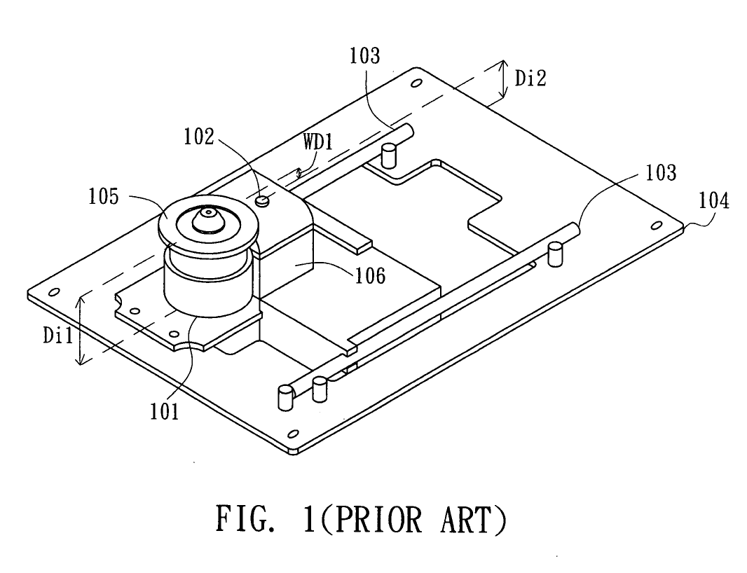

### DETAILED DESCRIPTION OF THE INVENTION

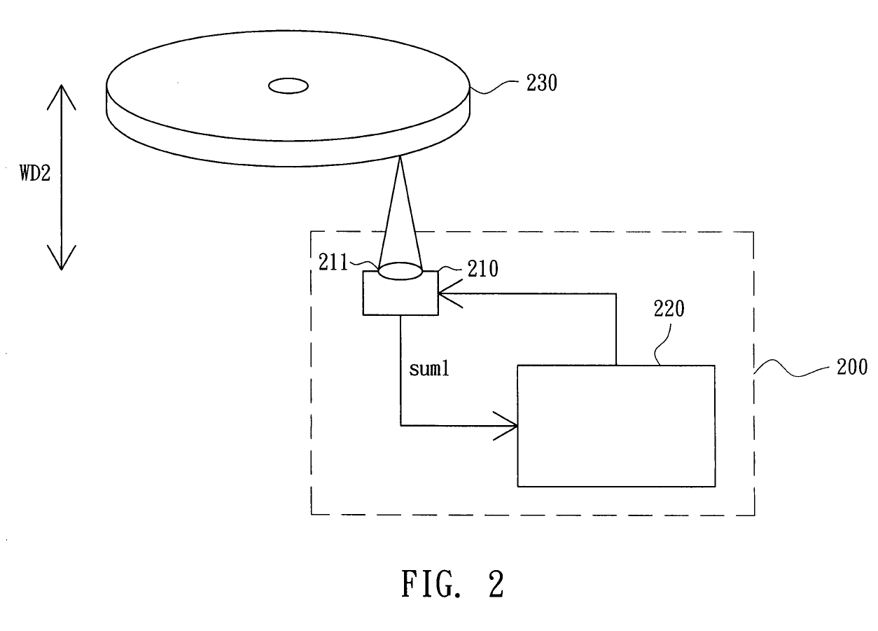

Referring to FIG. 2, an optical disk drive according to a preferred embodiment of the invention is shown. The optical disk drive 200 is for accessing a optical disk 230. The optical disk drive 200 includes an optical pick-up head 210 and a controller 220. The optical pick-up head 210 includes an objective lens 211. The distance between the optical disk 230 and the objective lens 211 is defined as a working distance WD2. Examples of the optical disk 230 include a Blu-ray Disk (BD).

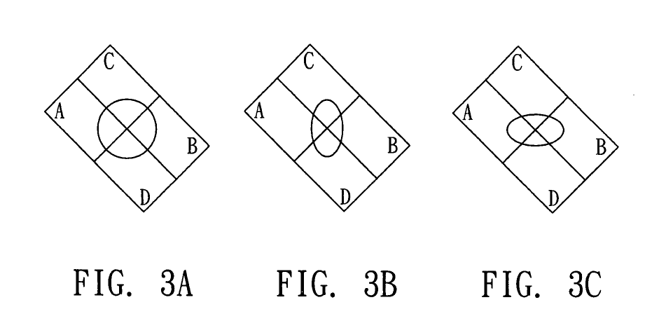

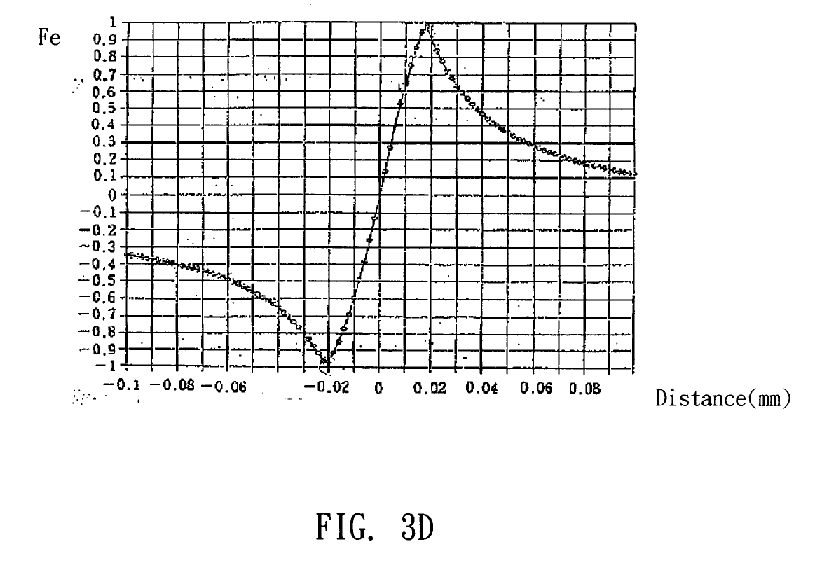

Referring to FIGS. 3A˜3C, a photo-detector of the optical pick-up head 210 is shown. The photo-detector is disposed in the optical pick-up head 210. The photo-detector has sub-photo-detectors A, B, C and D. The sub-photo-detectors A, B, C and D respectively generate a signal VA, a signal VB, a signal VC and a signal VD according to the beams respectively received by the sub-photo-detectors A, B, C and D. The value of the focus error signal Fe is expressed as follows:
Fe=(VA+VB)−(VC+VD);

In FIG. 3A, when the optical disk 230 and the objective lens 211 are correctly focused, the light point imaged on the photo-detector is circular, meanwhile, the value of the focus error signal Fe is zero. In FIG. 3B, when the distance between the optical disk 230 and the objective lens 211 is too close, the light point imaged on the photo-detector is oval, meanwhile, the value of the focus error signal Fe is smaller than zero. In FIG. 3C, when the distance between the optical disk 230 and the objective lens 211 is too large, the light point imaged on the photo-detector is oval, meanwhile, the value of the focus error signal Fe is larger than zero.

Referring to FIG. 3D, a diagram of the value of the focus error signal Fe vs. the working distance is shown. The shape of the relationship curve looks like an “S” and is therefore referred to as S-curve. In FIG. 3D, when the settings are as in FIG. 3A, the distance is defined to be 0; when the settings are as in FIG. 3B, the distance falls within the range of −0.1 mm to 0 mm; and when the settings are as in FIG. 3C, the distance falls within the range of 0.1 mm to 0 mm. When the distance is larger than 0.1 mm or smaller than −0.1 mm, the value of the focus error signal Fe approaches zero.

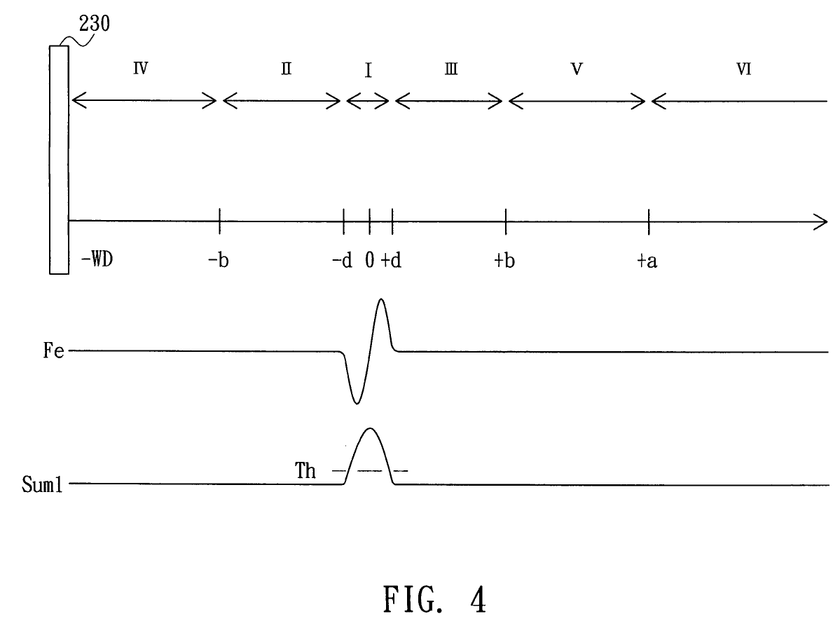

Referring to FIG. 4, relative positions between the objective lens of the invention and the optical disk are shown. With regard to the ideal working distance WD, that is, the distance from 0 mm to −WD in FIG. 4, normally an assembly tolerance is assigned to the working distance with the upper limit being +a and the lower limit being −b. This implies that the objective lens 211 complies with the standards as long as the objective lens 211 is within the range from +a to −b. On the contrary, if the objective lens 211 is outside the range from +a to −b, the working distance WD2 has to be adjusted. Therefore, when the objective lens 211 is in area I, area II, area III and area V, the working distance WD2 complies with the standards. When the objective lens 211 is in area IV and area VI, the working distance WD2 does not comply with the standards.

FIGS. 3A-3C show the state when the objective lens 211 is in a first area I. The S-curve of focus error signal Fe illustrated in FIG. 3D corresponds to the state when the objective lens 211 is in the first area I. The value of the sum signal sum1 is defined as (VA+VB+VC+VD). Within the first area I, the value of the sum signal sum1 is larger than a threshold value Th, and such characteristics may be used to determine which area the objective lens 211 is in, such that the range of the working distance WD2 is obtained for subsequent adjustment.

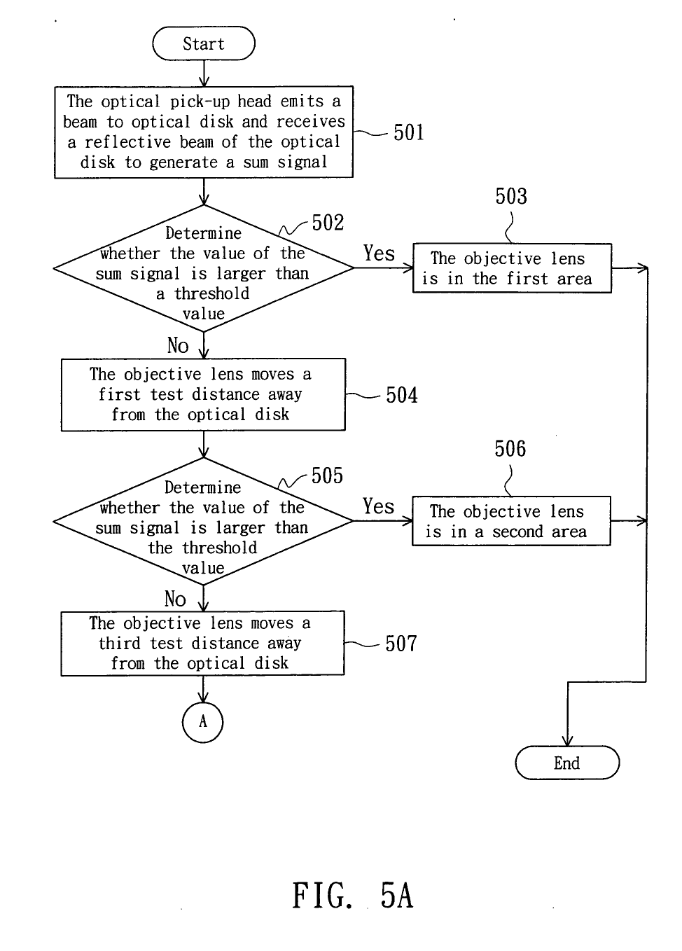

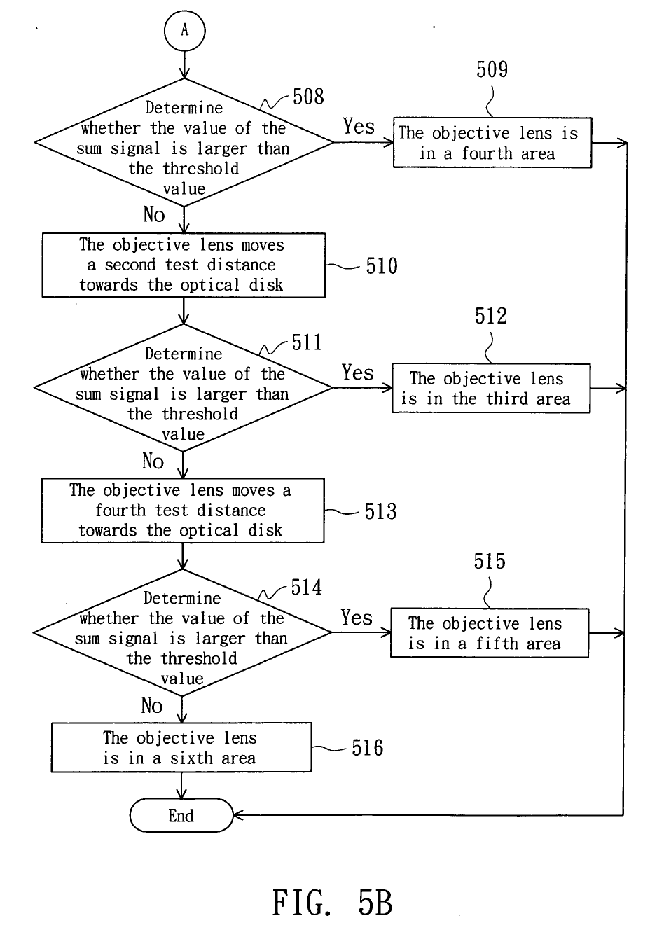

Referring to FIGS. 5A and 5B, are a flowchart of a method for determining the working distance according to a preferred embodiment of the invention is shown. Firstly, the method begins at step 501, the optical pick-up head 210 emits a beam to an optical disk 230 and receives a reflective beam of the optical disk 230 to generate a sum signal sum1. The objective lens 211 of the optical pick-up head 210 is in an initial position.

Next, proceed to step 502, whether the value of the sum signal sum1 is larger than the threshold value Th is determined. If yes, proceed to step 503, the objective lens 211 is in the first area I, otherwise proceed to step 504, the objective lens 211 moves a first test distance away from the optical disk 230. Referring to FIG. 4, the objective lens 211 moves a distance of “b” from the initial position in a direction away from the optical disk.

Next, proceed to step 505, whether the value of the sum signal is larger than the threshold value Th is determined. If yes, proceed to step 506, the objective lens 211 is in a second area II and the method is terminated, otherwise proceed to step 507, after the objective lens 211 returns to the initial position, the objective lens 211 moves a third test distance in a direction away from the optical disk 230. Referring to FIG. 4, the objective lens 211 moves a distance WD from the initial position in a direction away from the optical disk 230. Therefore, the third test distance is larger than the first test distance. Afterwards, proceed to step 508, whether the value of the sum signal sum1 is larger than the threshold value Th is determined. If yes, proceed to step 509, the objective lens 211 is in a fourth area IV, and the method is terminated. If the objective lens 211 is in the fourth area IV, the working distance WD2 does not comply with the standards and needs to be adjusted.

If the value of the sum signal sum1 is determined to be not larger than the threshold value Th in step 508, then proceed to step 510, after the objective lens 211 returns to the initial position, the objective lens 211 moves a second test distance towards the optical disk 230. Referring to FIG. 4, the objective lens 211 moves a distance of “b” from the initial position in a direction towards the optical disk 230. Next, proceed to step 511, whether the value of the sum signal sum1 is larger than the threshold value Th is determined. If yes, proceed to step 512, the objective lens 211 is in the third area III.

If the value of the sum signal sum1 is determined to be not larger than the threshold value Th in step 511, proceed to step 513, after the objective lens 211 returns to the initial position, the objective lens 211 moves a fourth test distance towards the optical disk 230. Referring to FIG. 4, the objective lens 211 moves a distance of “a” from the initial position in a direction towards the optical disk 230. Therefore, the fourth test distance is larger than the second test distance. Next, proceed to step 514, whether the value of the sum signal sum1 is larger than the threshold value Th is determined. If yes, proceed to step 515, the objective lens 211 is in a fifth area V, otherwise proceed to step 516, the objective lens 211 is in a sixth area VI. If the objective lens 211 is in the sixth area VI, the working distance WD2 does not comply with the standards and needs to be adjusted.

Compared with the conventional method of measuring working distance, the optical disk drive and method of determining working distance disclosed in the above embodiment of the invention avoid the error caused due to the accumulation of tolerance. The accumulation of tolerance may cause the objective lens to collide with the optical disk and result in permanent damages. According to the concepts of the invention, the working distance is directly measured without checking the height tolerance of the parts or inspecting the parts-feeding process, hence reducing the manufacturing cost.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method for determining working distance (WD) applied in an optical pick-up head, wherein the optical pick-up head is for accessing an optical disk, the optical pick-up head has an objective lens, the working distance is the distance between the optical disk and the objective lens, the method comprising:
emitting a beam to the optical disk by the optical pick-up head and receiving a reflective beam of the optical disk to generate a sum signal, wherein the objective lens is in an initial position; and
determining whether the value of the sum signal is larger than a threshold value;
if the value of the sum signal is larger than the threshold value, the objective lens being in a first area, otherwise, the objective lens moving a first test distance from the initial position in a direction away from the optical disk to check whether the objective lens is in a second area according to the sum signal and terminating the method if the objective lens is in the second area; and
if the objective lens is not in the second area, the objective lens moveing a second test distance from the initial position in a direction towards the optical disk and the sum signal being used to check whether the objective lens is in a third area.

2. The method according to claim 1, wherein the optical pick-up head generates a first signal (VA), a second signal (VB), a third signal (VC) and a fourth signal (VD) in response to a reflective beam of the optical disk, the sum signal is (VA+VB+VC+VD).

3. The method according to claim 1, wherein the step of moving the objective lens a first test distance away from the optical disk further comprises:
determining whether the value of the sum signal is larger than the threshold value; and
if the value of the sum signal is larger than the threshold value, the objective lens being in the second area and terminating the method.

4. The method according to claim 3, wherein between the step of moving the objective lens in a direction away from the optical disk and the step of moving the objective lens towards the optical disk further comprises:
the objective lens moving a third test distance from the initial position in a direction away from the optical disk; and
determining whether the value of the sum signal is larger than the threshold value; and
if the value of the sum signal is larger than the threshold value, the objective lens being in a fourth area and terminating the method.

5. The method according to claim 4, wherein the third test distance is larger than the first test distance.

6. The method according to claim 1, wherein the step of moving the objective lens towards the optical disk further comprises:
the objective lens moving the second test distance from the initial position in a direction towards the optical disk;
determining whether the value of the sum signal is larger than the threshold value; and
if the value of the sum signal is larger than the threshold value, the objective lens being in the third area and terminating the method.

7. The method according to claim 6, wherein after the step of moving the objective lens a second test distance towards the optical disk, if the value of the sum signal is not larger than the threshold value, then the method further comprises:
the objective lens moving a fourth test distance from the initial position in a direction towards the optical disk; and
determining whether the value of the sum signal is larger than the threshold value; and
if the value of the sum signal is larger than the threshold value, the objective lens being in a fifth area, otherwise the objective lens is in a sixth area.

8. The method according to claim 7, wherein the fourth test distance is larger than the second test distance.

9. The method according to claim 1, wherein the optical disk is a Blu-ray disk (BD).

10. A method for determining the working distance (WD) applied in an optical pick-up head, wherein the optical pick-up head is for accessing a optical disk, the optical pick-up head has an objective lens, the working distance is the distance between the optical disk and the objective lens, the method comprising:
the optical pick-up head to emitting a beam to the optical disk and receiving a reflective beam of the optical disk to generate a sum signal, wherein the objective lens is in an initial position;
the objective lens moving in a plurality of test distances from the initial position; and
determining the working distance of the optical pick-up head according to the value of the sum signal detected at the test distances by the optical pick-up head.

11. An optical disk drive for accessing an optical disk, the optical disk drive comprising:
an optical pick-up head having an objective lens, wherein the distance between the optical disk and the objective lens is defined as a working distance;
wherein, the optical pick-up head emits a beam to the optical disk and receives the a reflective beam of the optical disk to generate a sum signal, and the objective lens is in an initial position;
wherein, the optical disk drive determines whether the value of the sum signal is larger than a threshold value, and, if the value of the sum signal is larger than the threshold value, the objective lens is in a first area, otherwise, the objective lens moves a first test distance in a direction away from the optical disk to check whether the working distance is in a second area;
wherein, if the working distance is not in the second area, the objective lens moves a second test distance from the initial position in a direction towards the optical disk to check whether the objective lens is in a third area.

12. The optical disk drive according to claim 11, wherein the optical pick-up head generates a first signal (VA), a second signal (VB), a third signal (VC) and a fourth signal (VD) in response to a reflective beam of the optical disk, the sum signal is (VA+VB+VC+VD).

13. The optical disk drive according to claim 11, wherein the optical disk drive determines whether the value of the sum signal is larger than the threshold value after the objective lens moves the first test distance in a direction away from the optical disk, and, if the sum signal is larger than the threshold value, the objective lens is in a second area.

14. The optical disk drive according to claim 13, wherein if the value of the sum signal is not larger than the threshold value, then the objective lens moves a third test distance from the initial position in a direction away from the optical disk and the optical disk drive determines whether the value of the sum signal is larger than the threshold value, and, if the value of the sum signal is larger than the threshold value, the objective lens is in a fourth area.

15. The optical disk drive according to claim 14, wherein the third test distance is larger than the first test distance.

16. The optical disk drive according to claim 14, wherein the optical disk drive determines whether the value of the sum signal is larger than the threshold value after the objective lens moves the second test distance in a directon towards the optical disk, and, if the value of the sum signal is larger than the threshold value, the objective lens is in the third area.

17. The optical disk drive according to claim 16, wherein if the value of the sum signal is not larger than the threshold value after the objective lens moves the second test distance in a direction towards the optical disk, the objective lens moves a fourth test distance from the initial position in a direction towards the optical disk, the optical disk drive determines whether the value of the sum signal is larger than the threshold value, and, if the value of the sum signal is larger than the threshold value, the objective lens is in a fifth area, otherwise the objective lens is in a sixth area.

18. The optical disk drive according to claim 16, wherein the fourth test distance is larger than the second test distance.

19. The optical disk drive according to claim 11, wherein the optical disk is a Blu-ray disk (BD).
